(19) United States
(12) Patent Application Publication
(10) Pub. No.: US 2026/0107916 A1
(43) Pub. Date: Apr. 23, 2026

(54) APPARATUS FOR IMPROVING TEMPERATURE IN ANIMAL HOUSING ENVIRONMENT EXPOSED TO ELECTROMAGNETIC WAVE

(71) Applicant: ELECTRONICS AND TELECOMMUNICATIONS RESEARCH INSTITUTE, Daejeon (KR)

(72) Inventors: Sang Bong JEON, Daejeon (KR); Ae Kyoung LEE, Daejeon (KR); Duk Soo KWON, Daejeon (KR); Jung Ick MOON, Daejeon (KR); Hyung Do CHOI, Daejeon (KR); Seon-Eui HONG, Daejeon (KR)

(73) Assignee: ELECTRONICS AND TELECOMMUNICATIONS RESEARCH INSTITUTE, Daejeon (KR)

(21) Appl. No.: 19/339,234

(22) Filed: Sep. 24, 2025

(30) Foreign Application Priority Data
Oct. 22, 2024 (KR) 10-2024-0144679

(51) Int. Cl. A01K 1/03; A01K 1/035; G01K 3/00

(52) U.S. Cl. CPC A01K 1/0313; A01K 1/0356; G01K 3/005

(57) ABSTRACT

An apparatus for improving temperature conditions in an animal housing environment exposed to an electromagnetic wave includes a cooling pipe adhered to and disposed on an inner sidewall of an electromagnetic reverberation chamber to allow a coolant to flow therein and a watering system configured to supply the coolant to the cooling pipe, wherein the cooling pipe prevents an increase in internal temperature of the electromagnetic reverberation chamber.

### CROSS-REFERENCE TO RELATED APPLICATIONS

This application claims the benefit of the Korean Patent Application No. 10-2024-0144679 filed on Oct. 22, 2024, which is hereby incorporated by reference as if fully set forth herein.

### BACKGROUND

### Field of the Invention

The present disclosure relates to an apparatus for improving temperature conditions in an animal housing environment, and more particularly, to an apparatus for improving temperature conditions in an animal housing environment exposed to an electromagnetic wave.

### Discussion of the Related Art

Experiments are performed by using cells or animals, for research on an influence of an electromagnetic wave on a human body. Animal experiments are performed by a method which mainly exposes a rodent such as a rat or a mouse to an electromagnetic wave and evaluates a biological effect thereon.

Electromagnetic reverberation chambers of a metal-closed structure are being widely used as animal housing devices for electromagnetic wave exposure. This may provide a condition where an electromagnetic wave may be in only an electromagnetic reverberation chamber, and a cage and a rack are provided therein, thereby providing an environment where rodents are exposed to an electromagnetic wave in a housing environment where a body is not confined.

Because electromagnetic reverberation chambers have a closed structure, it is important to control the internal temperature, humidity, and ventilation of electromagnetic reverberation chambers to maintain an animal housing environment, so as to perform electromagnetic animal experiments. Particularly, housing environments (for example, a housing temperature, etc.) of an exposure group including animals exposed to an electromagnetic wave and a sham group including comparison-targeted animals unexposed to an electromagnetic wave should be maintained to be equal to each other. However, in electric field/electromagnetic wave exposure based on an electromagnetic reverberation chamber, a level of electromagnetic wave exposure may affect a temperature of a housing environment. That is, electromagnetic wave exposure causes an increase in temperature of a housing environment.

The related art has been developed for improving an internal animal housing environment of a cage, and development for improving a temperature of an animal housing environment caused by electromagnetic wave exposure is still insufficient.

### SUMMARY

An aspect of the present disclosure is directed to providing an apparatus for improving temperature conditions in an animal housing environment exposed to an electromagnetic wave.

To achieve these and other advantages and in accordance with the purpose of the invention, as embodied and broadly described herein, there is provided an apparatus for improving temperature conditions in an animal housing environment exposed to an electromagnetic wave, the apparatus including a cooling pipe adhered to and disposed on an inner sidewall of an electromagnetic reverberation chamber to allow a coolant to flow therein and a watering system configured to supply the coolant to the cooling pipe, wherein the cooling pipe prevents an increase in internal temperature of the electromagnetic reverberation chamber.

In an embodiment, the cooling pipe may prevent a temperature of the metal surface from increasing when the electromagnetic wave radiated from an antenna installed in the electromagnetic reverberation chamber reaches a metal surface configuring the inner sidewall, thereby preventing an increase in internal temperature of the electromagnetic reverberation chamber.

In an embodiment, the cooling pipe may be formed in a zigzag shape so that the coolant maximally circulates through a wide area of the inner sidewall.

In an embodiment, the apparatus may further include a temperature sensor disposed outside the electromagnetic reverberation chamber to measure the internal temperature of the electromagnetic reverberation chamber, wherein, when the internal temperature of the electromagnetic reverberation chamber measured by the temperature sensor falls to a reference temperature or less, the watering system may stop the supply of the coolant to the cooling pipe.

In an embodiment, the reference temperature may be a housing environment temperature of comparison-targeted animals unexposed to the electromagnetic wave.

In another aspect of the present invention, there is provided an apparatus for improving temperature conditions in an animal housing environment exposed to an electromagnetic wave, the apparatus including a cooling pipe adhered to and disposed on an inner sidewall of an electromagnetic reverberation chamber to allow a coolant to flow therein, a metal plate covering the cooling pipe, and a watering system configured to supply the coolant to the cooling pipe, wherein the cooling pipe prevents an increase in internal temperature of the electromagnetic reverberation chamber.

In an embodiment, the metal pipe may prevent an electromagnetic wave uniformity characteristic of the electromagnetic reverberation chamber from being reduced as the electromagnetic wave radiated from an antenna installed in the electromagnetic reverberation chamber is directly reflected to the cooling pipe.

In an embodiment, the cooling pipe may prevent a temperature of the metal surface from increasing when the electromagnetic wave radiated from an antenna installed in the electromagnetic reverberation chamber reaches a metal surface configuring the inner sidewall, thereby preventing an increase in internal temperature of the electromagnetic reverberation chamber.

In an embodiment, the cooling pipe may be formed in a zigzag shape so that the coolant maximally circulates through a wide area of the inner sidewall.

In another aspect of the present invention, there is provided an apparatus for improving temperature conditions in an animal housing environment exposed to an electromagnetic wave, the apparatus including a first watering system disposed outside an electromagnetic reverberation chamber to supply a coolant, a second watering system disposed in the electromagnetic reverberation chamber and supplied with the coolant through an inlet pipe, and a cooling pipe adhered to and disposed on an inner sidewall of an electromagnetic reverberation chamber and supplied with the coolant through an outlet pipe of the second watering system, wherein the cooling pipe prevents an increase in internal temperature of the electromagnetic reverberation chamber.

In an embodiment, the second watering system may be an auto watering rack configured to supply drinking water to an experiment-targeted animal of the electromagnetic reverberation chamber.

In an embodiment, the drinking water may be used as the coolant supplied from the cooling pipe.

In an embodiment, the apparatus may further include a temperature sensor disposed outside the electromagnetic reverberation chamber to measure the internal temperature of the electromagnetic reverberation chamber, wherein, when the internal temperature of the electromagnetic reverberation chamber measured by the temperature sensor falls to a reference temperature or less, the second watering system functioning as the auto watering rack may stop the supply of the drinking water, used as the coolant, to the cooling pipe.

According to embodiments of the present disclosure, a cooling system may prevent an increase in internal temperature of an electromagnetic reverberation chamber caused by electromagnetic wave exposure.

Moreover, a structure where a cooling pipe is covered by a metal plate may maintain the uniformity performance of a conventional electromagnetic reverberation chamber and may improve a temperature.

Moreover, as a conventional automatic watering system supplies water to the cooling pipe, water may be saved, and moreover, the conventional automatic watering system may be effectively used.

Based on such technology, a significant housing environment may be maintained under an animal experiment condition. Particularly, the present disclosure may provide a condition where housing environments of an exposure group and a sham group should be maintained to be equal to each other in an animal experiment.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the disclosure and are incorporated in and constitute a part of this application, illustrate embodiments of the disclosure and together with the description serve to explain the principle of the disclosure.

FIG. 1 is a graph showing a result obtained by measuring a temperature of air discharged through a vent of an electromagnetic reverberation chamber connected to the outside in a case (RF ON) where a radio frequency (RF) signal is radiated into the electromagnetic reverberation chamber and in a case (RF OFF) where the RF signal is not radiated.

FIG. 2 is a diagram for describing an apparatus for improving temperature conditions in an animal housing environment exposed to an electromagnetic wave according to a first embodiment of the present disclosure.

FIG. 3 is a front view for describing a shape of a cooling pipe of FIG. 2.

FIG. 4 is a diagram for describing an apparatus for improving temperature conditions in an animal housing environment exposed to an electromagnetic wave according to a second embodiment of the present disclosure.

FIG. 5 is a front view for describing a metal plate covering a cooling pipe of FIG. 4.

FIG. 6 is a diagram for describing an apparatus for improving temperature conditions in an animal housing environment exposed to an electromagnetic wave according to a third embodiment of the present disclosure.

### DETAILED DESCRIPTION OF THE INVENTION

Hereinafter, embodiments of the present disclosure will be described, in detail, with reference to the accompanying drawings. The terms or words used in this specification and claims should not be construed as being limited to the usual or dictionary meaning and should be interpreted as meaning and concept consistent with the technical idea of the present disclosure based on the principle that the inventor can be his/her own lexicographer to appropriately define the concept of the term to explain his/her invention in the best way. The embodiments described in this specification and the configurations shown in the drawings are only some of the embodiments of the present disclosure and do not represent all of the technical ideas, aspects, and features of the present disclosure. Accordingly, it should be understood that there may be various equivalents and modifications that can replace or modify the embodiments described herein at the time of filing this application. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof. Also, when describing embodiments of the present disclosure, “may perform” and “may be” may include one or more embodiments of the present disclosure. Also, in order to help understand the present disclosure, the accompanying drawings are not illustrated based on a real scale, and dimensions of some elements may be exaggeratedly illustrated. Also, in different embodiments, like reference numerals may refer to like elements.

Description that two comparison targets are the same may denote ‘substantially the same’. Therefore, substantially the same may include a case which has a deviation regarded at a low level in those skilled in the art, and for example, has a deviation of less than 5%. Also, an arbitrary parameter being uniform in a certain region may denote being uniform at an average point of view. Although “first” and “second” are used for describing various elements, but the elements are not limited by the terms. Such terms are used for distinguishing one element from another element. Therefore, a first element described below may be a second element within the technical scope of the present invention.

Herein, if there is no description opposite thereto, each element may be singular, or may be plural. An arbitrary element being disposed “at an upper portion (or lower portion)” of an element or “on (or under) ” the element may denote that another element is interposed between the element and an arbitrary element disposed on (or under) the element, in addition to that an arbitrary element is disposed in contact with an upper surface (or lower surface) of the element.

Moreover, when an element is described as being “connected to”, “coupled to”, or “contacting” another element, this should be understood that the elements may be directly connected to or contact each other, but another element may be “disposed” between the elements, or the elements may be “connected to”, “coupled to”, or “contact” each other through another element. Also, when it is assumed that a certain portion is electrically coupled to another portion, this may include a case where the portions are coupled to each other with another element therebetween, in addition to a case where the portions are directly coupled to each other.

When “A and/or B” are/is described herein, this may denote A, B or A and B unless oppositely described. That is, “and/or” may include all combinations or an arbitrary combination of a plurality of items listed. When “C to D” are described, this may denote C or more and D or less unless oppositely described.

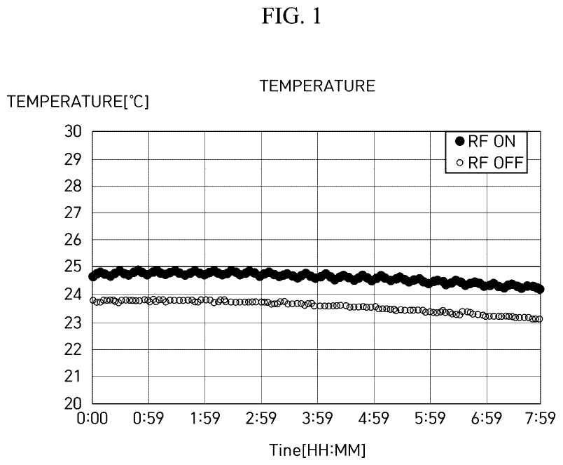

FIG. 1 is a graph showing a result obtained by measuring a temperature of air discharged through a vent of an electromagnetic reverberation chamber connected to the outside in a case (RF ON) where a radio frequency (RF) signal is radiated into the electromagnetic reverberation chamber and in a case (RF OFF) where the RF signal is not radiated.

Referring to FIG. 1, in a case which performs research on an electromagnetic wave exposure animal experiment based on an electromagnetic reverberation chamber, a device generating an electromagnetic wave in the electromagnetic reverberation chamber may be necessarily needed. To this end, a signal generating device for generating an electromagnetic wave may be installed outside the electromagnetic reverberation chamber, and a generated signal may be transferred to an internal antenna of the electromagnetic reverberation chamber through an RF cable. The antenna may radiate an RF signal, and thus, may allow an electromagnetic wave to be in the electromagnetic reverberation chamber. At this time, the RF signal radiated from the antenna may increase a temperature of a metal surface configuring an inner sidewall of the electromagnetic reverberation chamber, and the increased temperature of the metal surface may be diffused by a convection phenomenon and may provide a cause which increases a temperature of a housing environment.

Comparing temperatures of internal housing environments of the electromagnetic reverberation chamber in a case RF_ON where an RF signal is radiated from the antenna and a case RF_OFF where the RF signal is not radiated, as illustrated in FIG. 1, a temperature of air may have a difference of about 1° C. between the case RF_ON and the case RF_OFF.

Such a temperature difference may denote that a temperature environment of an animal housing environment differs between an RF exposure group and a sham group in an animal experiment on electromagnetic wave exposure performed based on the electromagnetic reverberation chamber.

An embodiment of the present disclosure may be for preventing the occurrence of a temperature change in an animal housing environment caused by an electromagnetic wave (RF signal) radiated from the antenna. Such a purpose may be accomplished by preventing a temperature of the metal surface configuring the inner sidewall of the electromagnetic reverberation chamber from increasing due to the electromagnetic wave (RF signal) radiated from the antenna.

Hereinafter, various embodiments of the present disclosure for preventing a temperature change in an animal housing environment from occurring because a temperature of a metal surface configuring an inner sidewall of an electromagnetic reverberation chamber increases due to an electromagnetic wave (RF signal) radiated from the antenna, will be described in detail with reference to the accompanying drawings.

### First Embodiment

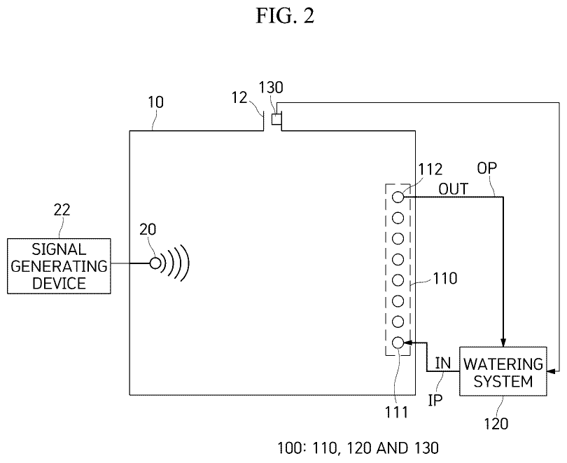

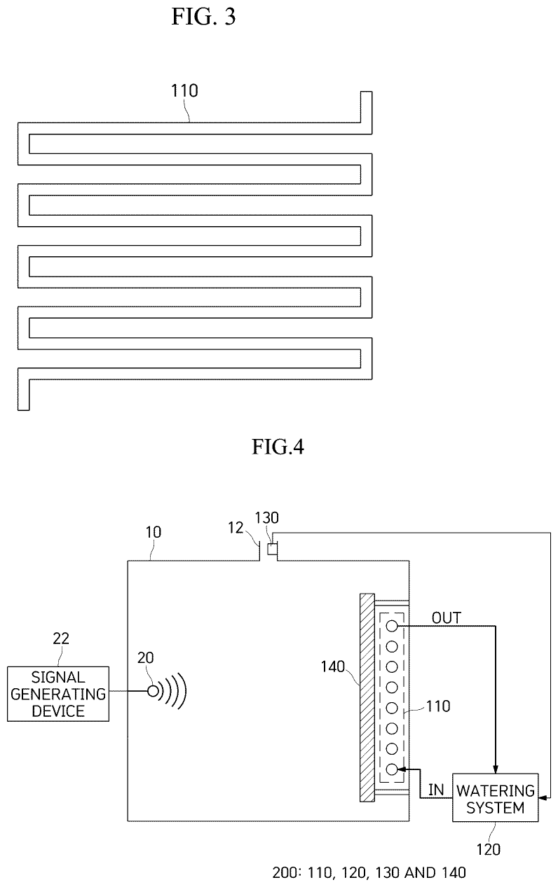

FIG. 2 is a diagram for describing an apparatus 100 for improving temperature conditions in an animal housing environment exposed to an electromagnetic wave according to a first embodiment of the present disclosure. FIG. 3 is a front view for describing a shape of a cooling pipe of FIG. 2.

Referring to FIGS. 2 and 3, the apparatus 100 for improving temperature conditions in an animal housing environment exposed to an electromagnetic wave according to the first embodiment of the present disclosure may include a cooling pipe 110 and a watering system 120.

The cooling pipe 110 may be adhered to and disposed (installed) on an inner sidewall of an electromagnetic reverberation chamber 10. A coolant flow in the cooling pipe 110. The inner sidewall where the cooling pipe 110 is disposed (installed) may be a sidewall facing an antenna 20 installed in the electromagnetic reverberation chamber 10. Here, the antenna 20 may be connected to a signal generating device 22 by an RF cable and may radiate a signal, received from the signal generating device 22, as an RF signal to an inner portion of the electromagnetic reverberation chamber 10 so as to form an electromagnetic wave in the electromagnetic reverberation chamber 10.

The coolant flowing in the cooling pipe 110 may prevent an increase in internal temperature of the electromagnetic reverberation chamber 10. As used herein, the term ‘internal temperature’ means a predetermined internal temperature. In more detail, the coolant flowing in the cooling pipe 110 may prevent a temperature of the metal surface from increasing when an electromagnetic wave (RF signal) radiated from the antenna installed in the electromagnetic reverberation chamber 10 reaches the metal surface configuring the inner sidewall. That is, the coolant flowing in the cooling pipe 110 may absorb heat of the metal surface configuring the inner sidewall. Accordingly, the cooling pipe 110 may prevent an increase in internal temperature of the electromagnetic reverberation chamber 10.

The watering system 120 may be disposed (installed) outside the electromagnetic reverberation chamber 10. The watering system 120 may be connected to one end portion 111 of the cooling pipe 110 through an inlet pipe IP. Accordingly, the watering system 120 may supply a coolant of appropriate temperature to the cooling pipe 110, and thus, the coolant of appropriate temperature may flow in the cooling pipe 110.

Moreover, the watering system 120 may be connected to the other end portion 112 of the cooling pipe 110 through an outlet pipe OP. Accordingly, a coolant which has absorbed heat occurring in the metal surface configuring the inner sidewall may be transferred to the watering system 120 through the outlet pipe OP, and the watering system 120 may discharge the heat-absorbed coolant to the outside.

The cooling pipe 110 may be formed so that a coolant flowing therein circulates through a maximally wide surface of the metal surface configuring the inner sidewall. For example, as illustrated in FIG. 2, the cooling pipe 110 may be formed in a zigzag shape so that a coolant maximally circulates through a wide area of the metal surface configuring the inner sidewall. However, the present disclosure is not limited thereto, and a structure which allows a coolant to maximally circulate through a wide area of the metal surface configuring the inner sidewall is not limited in shape.

Optionally, the apparatus 100 according to the first embodiment of the present disclosure may further include a temperature sensor 130. The temperature sensor 130 may be disposed in an exhaust port 12, through which air is discharged, of the electromagnetic reverberation chamber 10 and may additionally measure an internal temperature of the electromagnetic reverberation chamber 10.

The internal temperature of the electromagnetic reverberation chamber 10 measured by the temperature sensor 130 may be used to control a watering operation of the watering system 120. For example, when the internal temperature of the electromagnetic reverberation chamber 10 measured by the temperature sensor 130 falls to a reference temperature or less, the watering system 120 may stop the supply of the coolant to the cooling pipe 110. Accordingly, a coolant may be saved. Here, the reference temperature may be a housing environment temperature of comparison-targeted animals (sham group) unexposed to the electromagnetic wave.

### Second Embodiment

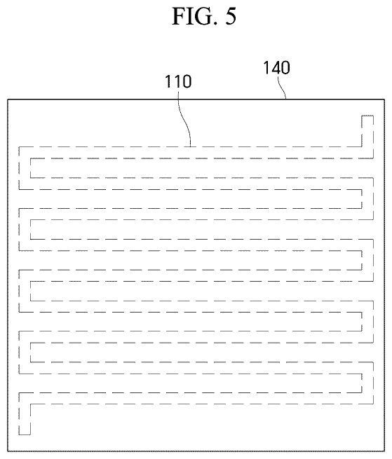

FIG. 4 is a diagram for describing an apparatus 200 for improving temperature conditions in an animal housing environment exposed to an electromagnetic wave according to a second embodiment of the present disclosure, and FIG. 5 is a front view for describing a metal plate covering a cooling pipe of FIG. 4. In FIG. 5, a cooling pipe disposed under a metal plate is illustrated by a dotted line.

Referring to FIGS. 4 and 5, except for that the apparatus 200 further includes a metal plate 140 of a plate shape covering the cooling pipe 110, the apparatus 200 for improving temperature conditions in an animal housing environment exposed to an electromagnetic wave according to the second embodiment of the present disclosure may be the same as the first embodiment described above. Accordingly, descriptions of the cooling pipe 110 and the watering system 120 included in the apparatus 200 according to the second embodiment of the present disclosure and the temperature sensor 130 which may be optionally included therein may be replaced with the descriptions of the first embodiment given above with reference to FIGS. 3 and 4.

The metal plate 140 may prevent an electromagnetic wave uniformity characteristic of the electromagnetic reverberation chamber 10 from being reduced as the electromagnetic wave (RF signal) radiated from the antenna 20 installed in the electromagnetic reverberation chamber 10 is directly reflected to the cooling pipe 110. Here, the electromagnetic wave uniformity characteristic may denote a characteristic representing the degree to which an electromagnetic wave is uniformly distributed in the electromagnetic reverberation chamber 10 which is an experiment space.

A main purpose of the electromagnetic reverberation chamber 10 may allow an experiment-targeted animal to be exposed to the same electromagnetic wave regardless of a position at which the experiment-targeted animal is disposed, based on a uniform distribution of an electromagnetic wave. When the cooling pipe 110 is covered by the metal plate 140, a reproducibility of an experiment result may be guaranteed, and a variation of an exposure level may be minimized.

### Third Embodiment

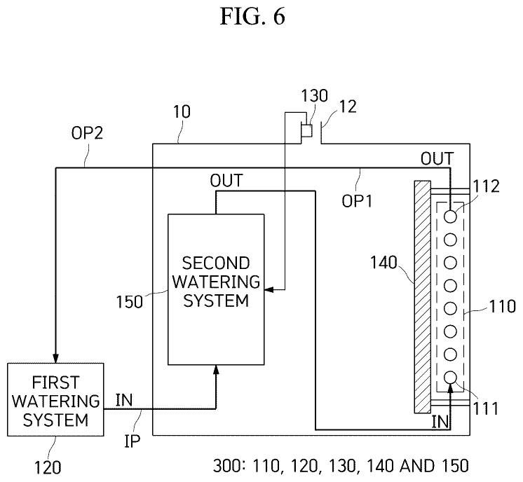

FIG. 6 is a diagram for describing an apparatus 300 for improving temperature conditions in an animal housing environment exposed to an electromagnetic wave according to a third embodiment of the present disclosure.

Referring to FIG. 6, except for that the apparatus 300 further includes a second watering system 150, the apparatus 300 for improving temperature conditions in an animal housing environment exposed to an electromagnetic wave according to the third embodiment of the present disclosure may be the same as the second embodiment described above. Accordingly, in the apparatus 300 according to the third embodiment of the present disclosure, the term “watering system 120” of FIGS. 2 and 4 may be changed to a “first watering system”, and the temperature sensor 130 and/or the metal plate 140 according to the first and/or second embodiment(s) described above may be optionally included therein.

The second watering system 150 may be disposed (installed) in the electromagnetic reverberation chamber 10 and may be connected to the first watering system 120 which supplies a coolant, based on an inlet pipe IP. Also, the second watering system 150 may be connected to the one end portion 111 of the cooling pipe 110 through a first outlet pipe OP1. Also, the other end portion 112 of the cooling pipe 110 may be connected to the first watering system 120 through a second outlet pipe OP2.

The first watering system 120, the second watering system 150, and cooling pipe 110 may be connected to the inlet pipe IP by the outlet pipes OP1 and OP2, and thus, the coolant supplied from the first watering system 120 may be supplied to the cooling pipe 110. That is, the second watering system 150 disposed (installed) in the electromagnetic reverberation chamber 10 may function as an intermediate medium which transfers the coolant, supplied from the first watering system 120, to the cooling pipe 110.

The second watering system 150 may further perform a function of providing drinking water (water) to an experiment-targeted animal of the electromagnetic reverberation chamber 10, in addition to functioning as the intermediate medium. That is, the second watering system 150 may be a conventional auto watering rack which provides the drinking water (water) to the experiment-targeted animal.

When the second watering system 150 functioning as the conventional auto watering rack is used as the intermediate medium which transfers the coolant, supplied from the first watering system 120, to the cooling pipe 110, the total amount of water used for drinking and cooling may be saved. At this time, by using the temperature sensor 130 measuring an internal temperature of the electromagnetic reverberation chamber 10, when the second watering system 150 functioning as the auto watering rack controls the amount of coolant (drinking water) supplied to the cooling pipe 110, the total amount of used water may be more saved.

For example, when the internal temperature of the electromagnetic reverberation chamber 10 measured by the temperature sensor 130 falls to the reference temperature or less, the second watering system 150 functioning as the auto watering rack may be configured to supply drinking water to experiment-targeted animals of the electromagnetic reverberation chamber 10 but stop the supply of the drinking water, used as the coolant, to the cooling pipe 110.

According to embodiments of the present disclosure, a cooling system may prevent an increase in internal temperature of an electromagnetic reverberation chamber caused by electromagnetic wave exposure.

Moreover, a structure where a cooling pipe is covered by a metal plate may maintain the uniformity performance of a conventional electromagnetic reverberation chamber and may improve a temperature.

Moreover, as a conventional automatic watering system supplies water to the cooling pipe, water may be saved, and moreover, the conventional automatic watering system may be effectively used.

Based on such technology, a significant housing environment may be maintained under an animal experiment condition. Particularly, the present disclosure may provide a condition where housing environments of an exposure group and a sham group should be maintained to be equal to each other in an animal experiment.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. An apparatus for improving temperature conditions in an animal housing environment exposed to an electromagnetic wave, the apparatus comprising:
a cooling pipe adhered to and disposed on an inner sidewall of an electromagnetic reverberation chamber to allow a coolant to flow therein; and
a watering system configured to supply the coolant to the cooling pipe,
wherein the cooling pipe prevents an increase in internal temperature of the electromagnetic reverberation chamber.

2. The apparatus of claim 1, wherein the cooling pipe prevents a temperature of the metal surface from increasing when the electromagnetic wave radiated from an antenna installed in the electromagnetic reverberation chamber reaches a metal surface configuring the inner sidewall, thereby preventing an increase in internal temperature of the electromagnetic reverberation chamber.

3. The apparatus of claim 1, wherein the cooling pipe is formed in a zigzag shape so that the coolant maximally circulates through a wide area of the inner sidewall.

4. The apparatus of claim 1, further comprising a temperature sensor disposed outside the electromagnetic reverberation chamber to measure the internal temperature of the electromagnetic reverberation chamber,
wherein, when the internal temperature of the electromagnetic reverberation chamber measured by the temperature sensor falls to a reference temperature or less, the watering system stops the supply of the coolant to the cooling pipe.

5. The apparatus of claim 4, wherein the reference temperature is a housing environment temperature of comparison-targeted animals unexposed to the electromagnetic wave.

6. An apparatus for improving temperature conditions in an animal housing environment exposed to an electromagnetic wave, the apparatus comprising:
a cooling pipe adhered to and disposed on an inner sidewall of an electromagnetic reverberation chamber to allow a coolant to flow therein;
a metal plate covering the cooling pipe; and
a watering system configured to supply the coolant to the cooling pipe,
wherein the cooling pipe prevents an increase in internal temperature of the electromagnetic reverberation chamber.

7. The apparatus of claim 6, wherein the metal pipe prevents an electromagnetic wave uniformity characteristic of the electromagnetic reverberation chamber from being reduced as the electromagnetic wave radiated from an antenna installed in the electromagnetic reverberation chamber is directly reflected to the cooling pipe.

8. The apparatus of claim 6, wherein the cooling pipe prevents a temperature of the metal surface from increasing when the electromagnetic wave radiated from an antenna installed in the electromagnetic reverberation chamber reaches a metal surface configuring the inner sidewall, thereby preventing an increase in internal temperature of the electromagnetic reverberation chamber.

9. The apparatus of claim 6, wherein the cooling pipe is formed in a zigzag shape so that the coolant maximally circulates through a wide area of the inner sidewall.

10. The apparatus of claim 6, further comprising a temperature sensor disposed outside the electromagnetic reverberation chamber to measure the internal temperature of the electromagnetic reverberation chamber,
wherein, when the internal temperature of the electromagnetic reverberation chamber measured by the temperature sensor falls to a reference temperature or less, the watering system stops the supply of the coolant to the cooling pipe.

11. The apparatus of claim 10, wherein the reference temperature is a housing environment temperature of comparison-targeted animals unexposed to the electromagnetic wave.

12. An apparatus for improving temperature conditions in an animal housing environment exposed to an electromagnetic wave, the apparatus comprising:
a first watering system disposed outside an electromagnetic reverberation chamber to supply a coolant;
a second watering system disposed in the electromagnetic reverberation chamber and supplied with the coolant through an inlet pipe; and
a cooling pipe adhered to and disposed on an inner sidewall of an electromagnetic reverberation chamber and supplied with the coolant through an outlet pipe of the second watering system,
wherein the cooling pipe prevents an increase in internal temperature of the electromagnetic reverberation chamber.

13. The apparatus of claim 12, wherein the second watering system is an auto watering rack configured to supply drinking water to an experiment-targeted animal of the electromagnetic reverberation chamber.

14. The apparatus of claim 13, wherein the drinking water is used as the coolant supplied from the cooling pipe.

15. The apparatus of claim 13, further comprising a temperature sensor disposed outside the electromagnetic reverberation chamber to measure the internal temperature of the electromagnetic reverberation chamber,
wherein, when the internal temperature of the electromagnetic reverberation chamber measured by the temperature sensor falls to a reference temperature or less, the second watering system functioning as the auto watering rack stops the supply of the drinking water, used as the coolant, to the cooling pipe.

16. The apparatus of claim 12, wherein the cooling pipe prevents a temperature of the metal surface from increasing when the electromagnetic wave radiated from an antenna installed in the electromagnetic reverberation chamber reaches a metal surface configuring the inner sidewall, thereby preventing an increase in internal temperature of the electromagnetic reverberation chamber.

17. The apparatus of claim 12, further comprising a metal plate covering the cooling pipe,
wherein the metal pipe prevents an electromagnetic wave uniformity characteristic of the electromagnetic reverberation chamber from being reduced as the electromagnetic wave radiated from an antenna installed in the electromagnetic reverberation chamber is directly reflected to the cooling pipe.
